(19) United States
(12) Patent Application Publication
(10) Pub. No.: US 2013/0255056 A1
(43) Pub. Date: Oct. 3, 2013

(54) FULL-SCALE ARCHITECTURAL TEMPLATE AND METHOD FOR INSTALLING CONSTRUCTION ELEMENTS FOR EXHIBITIONS, TRADE SHOWS, CONVENTIONS AND EVENTS

(71) Applicant: Freeman Capital Company, Las Vegas, NV (US)

(72) Inventors: Jay Atherton, Southlake, TX (US); Brian West, Grapevine, TX (US); Carl Edward Crow, Grand Prairie, TX (US)

(21) Appl. No.: 13/907,735

(22) Filed: May 31, 2013

Related U.S. Application Data
(63) Continuation-in-part of application No. 12/904,321, filed on Oct. 14, 2010.

(51) Int. Cl. G01B 3/00

(52) U.S. Cl. CPC G01B 3/00
USPC 29/426.2; 29/464; 33/562

(57) ABSTRACT

A method of installing temporary construction elements for an event is disclosed. The method may include creating a digital file of an architectural template illustrating the temporary construction elements. The method may further include printing the digital file as a full-scale architectural template. The full-scale architectural template may comprise one or more sheets capable of protecting the floor during installation of the temporary construction elements, each sheet being a portion of the full-scale template. The method may further include placing and aligning the sheets on the floor so that the markings are positioned in the same location as the corresponding temporary construction elements should be and attaching the sheets to the floor. The method may further include installing the temporary construction elements on the sheets in accordance with the markings. The method may further include removing the sheets after installation of the construction elements.

### CROSS-REFERENCE TO RELATED APPLICATIONS

This application claims priority from, and hereby incorporates by reference for all purposes, U.S. patent application Ser. No. 12/904,321, entitled “Full-Scale Architectural Template and Method for Installing Construction Elements for Exhibitions, Trade Shows, Conventions and Events Without Damaging Carpet or Floor,” naming Jay Atherton, et al. as inventors, and filed Oct. 14, 2010.

### BACKGROUND

1. Field

This disclosure relates generally to architectural templates and, more particularly, this disclosure relates to a full-scale architectural template and method for installing temporary construction elements for exhibitions, trade shows, conventions and corporate events without damaging a surface, for example, a carpet or a floor.

2. Description of the Related Art

Exhibitions, trade shows, conventions and other events are generally hosted in buildings capable of accommodating a large number of people and capable of repeated use for a variety of events. For these events, the building is typically sub-divided into many booths and other smaller meeting spaces. Construction elements such as walls and cabinets are assembled in designated locations to create the booths and other meeting spaces. Also, HVAC equipments, electrical and data services lines are installed and furniture is transported to designated locations.

A disadvantage of existing methods is during transportation of the construction elements, HVAC equipments, electrical and data services lines and furniture, a surface onto which the construction elements are installed, such as, for example, a carpet or a floor, can easily be damaged. A further disadvantage of existing methods is that the walls and cabinets are assembled directly on the carpet or on the floor, thereby damaging the carpet or the floor. A further disadvantage of existing methods is the exact locations for the booths and other construction elements are identified according to a floor-plan, which is time consuming and often results in inaccurate placement of construction elements.

### SUMMARY

In a first aspect, there is provided a method of installing temporary construction elements for an event. The method may include placing a sheet on a surface, wherein the sheet includes a portion of a full-scale architectural template having markings indicating the position of temporary construction elements. The method may also include removably attaching the sheet to the surface. The method may additionally include installing the temporary construction elements on the sheet in accordance with the markings and then uninstalling the temporary construction elements.

In certain embodiments, the method also includes removing the sheet from the surface.

In other embodiments, the method also includes aligning the sheet with an adjacent sheet by aligning alignment arrows of the sheet with alignment arrows on the adjacent sheet.

In yet another embodiment, placing the sheet on the surface includes placing a second sheet adjacent to the sheet so that a portion of the second sheet overlaps the sheet.

In still another embodiment, the sheet includes an advertisement printed on the sheet.

In a second aspect, there is provided a method of installing temporary construction elements for an event that includes placing a sheet on a surface, the sheet including a portion of an architectural template including markings indicating the position of temporary construction elements. The method may also include removably securing the sheets to the surface and then installing the temporary construction elements on the sheet in accordance with the markings. The method may then include removing the sheet from the surface.

In certain embodiments, removing the sheet from the surface includes pulling the sheet out from under the temporary construction elements.

In other embodiments, the method includes uninstalling the temporary construction elements.

In yet another embodiment, placing the sheets on the floor includes securing the sheet to an adjacent sheet so that a portion of the sheet overlaps the adjacent sheet.

In still another embodiment, the sheets include grid lines as a background to aid in aligning the sheets.

In some embodiments, the temporary construction elements include at least one of portable furniture, a booth, a temporary wall, a door, a cabinet, an electrical cable, a data service line and a piece of HVAC equipment.

In a third aspect, there is described a full-scale architectural template for installing temporary construction elements for an event that includes one or more sheets, each sheet being a portion of the full-scale architectural template. In certain embodiments, the sheets have markings indicating the position of the temporary construction elements for the event. In some embodiments, the temporary construction elements include at least one of portable furniture, a booth, a temporary wall, a door, a cabinet, an electrical cable, a data service line and a piece of HVAC equipment.

In certain embodiments, the sheets are made of one or more of a vinyl material, a fabric and a plastic material.

In other embodiments, the sheets are up to about 8 mm thick.

In yet another embodiment, the sheets include a vinyl face and a woven nylon backing.

In still another embodiment, the sheets are made of a PVC coated woven nylon.

In some embodiments, the sheets include a woven material.

In another embodiment, the sheets include a non-woven material.

In certain embodiments, the sheets are made of a high density polyethylene.

### BRIEF DESCRIPTION OF THE DRAWINGS

Reference is made to the following detailed description of the preferred embodiments, taken in conjunction with the accompanying drawings in which reference characters designate like or similar elements throughout the several figures of the drawings.

FIG. 1A is a flow diagram of the steps of installing construction elements in accordance with one embodiment.

FIG. 2 illustrates a floor for an event.

FIG. 3 shows a full-scale architectural template comprising a plurality of sheets being laid on a carpet.

FIG. 4 shows a full-scale architectural template installed on a carpet.

FIG. 5 shows booths being installed directly on sheets.

### DETAILED DESCRIPTION OF THE EMBODIMENTS

In one embodiment, a method is described for protecting a carpet, floor or other surface during installation of construction elements and during placement of furniture for an event. The event may be a convention, an exhibition, a trade show, a meeting, a conference or any other event requiring construction of a facility and/or placement of construction elements.

In another embodiment, a full-scale architectural template is described which protects a carpet, floor or other surface during installation of temporary construction elements and during placement of furniture. The temporary construction elements may be booths, temporary walls, doors, cabinets, electrical cables, data services lines, HVAC equipments or any other temporary element which is to be eventually removed. The temporary construction elements are generally configured to be removed after an event but may be removed after several events or some other period of time.

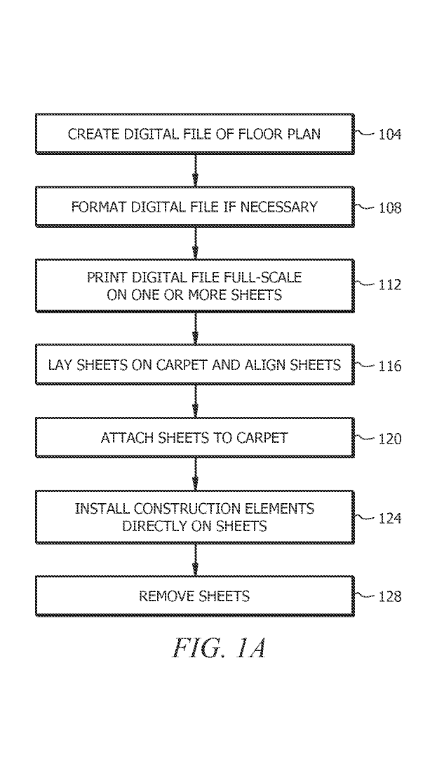

FIG. 1 is a flow diagram of the steps of installing temporary construction elements and for placing furniture for an event in accordance with one embodiment. In step 104, a digital file of an architectural template for the event is created. The digital file may be created using any commercially available computer aided design tool. The digital file alternatively may be created by scanning in a drawing of a floor plan. The architectural template illustrates the layout of the temporary construction elements such as booths, temporary walls, doors, cabinets, televisions, lighting, credenzas, shelves, banners, showcases, light panels, utilities, data services lines, as well as the location of furniture.

If necessary, in step 108, the digital file may be converted to an appropriate format prior to printing. The formatting may involve, for example, adjustments to account for stretching of the material of the sheets during printing, transportation and/or securing to the surface.

In step 112, the digital file is printed full-scale on one or more sheets. The sheets may be made of paper, plastic, fabric, vinyl or other material suitable for application to a surface, such as a carpet or a floor. In some embodiments, the sheets include a vinyl face and a woven nylon backing. In some embodiments, the sheets are made of a PVC coated woven nylon. In some embodiments, the sheets include a woven material such as a woven nylon, while in other embodiments the sheets do not include a woven material. In some embodiments, the sheets include a high density polyethylene and may be made of, for example, Tyvek® made by DuPont of Wilmington, Del. USA.

In some embodiments, the sheets are up to about 8 mm thick. In other embodiments, the sheets may be thicker than 8 mm. In some embodiments, the sheets are flexible and possess required structural integrity to protect the carpet or the floor, as the construction elements will be built directly on the sheets. The construction elements may be represented by printed lines or other markings on the sheets.

In one implementation, the full-scale architectural template is printed onto a plurality of sheets, each being a portion of the architectural template. For example, the architectural template may be printed onto a plurality of 15 foot wide sheets, each containing a portion of the floor plan. Identifiers may be added to the sheets to aid in aligning the sheets during placement on the carpet or the floor. Other markings such as grid lines may be printed on the sheets as background to aid in aligning the sheets during installation. In one embodiment, the identifiers are arrows and adjacent sheets are aligned by aligning a point of an arrow of one sheet with the point of an arrow of an adjacent sheet. In some embodiments, the sheets may also include advertisements printed on the sheets.

The sheets are transported to the event venue for installation on the carpet, floor or other surface.

In step 116, the sheets are laid on the surface and are aligned using the identifiers. Since the construction elements are constructed directly on the sheets, it is necessary that the sheets are properly aligned so that the markings representing the construction elements are in the same location as the corresponding construction elements. In some embodiments, a first sheet is aligned with a wall or other feature of the building and then subsequent sheets are aligned with respect to the first sheet. For example, a corner of the first sheet may be aligned with a corner of the building and subsequent sheets may be aligned with the first sheet once it has been fully deployed. The sheets may be shaped to correspond to the overall shape of the building surface. Thus, for example, a first sheet may be shorter than other sheets due to the shape of the building surface. In addition, the outer contour of the sheets may be cut to correspond to the outline of the building surface to accommodate, for example, for diagonally disposed building walls.

In step 120, the sheets are attached or secured to the floor, carpet or other surface, and are also secured together by tapes or adhesives. In step 124, the temporary construction elements are built directly on the sheets in accordance with the markings. For example, booths, temporary walls, doors, and cabinets are built on the sheets in accordance with the markings. Also, furniture is moved to locations according to the markings. It will be appreciated that the sheets provide a protective cover to the carpet, floor or other surface during the construction phase.

After the temporary construction elements are built and the furniture is in place, in step 128, the sheets are removed from under the construction elements and the furniture. The sheets may be cut out using a sharp blade or a knife and/or may be pulled out from under the temporary construction elements. In some embodiments, part or all of the sheets may be left under the temporary construction elements when, for example, a portion of the sheets is covered by the temporary construction elements.

In some embodiments, sheets that including a portion of a full-scale architectural template are delivered to a user, for example, an installer, who places the sheet on a surface. The sheets may then be removably attached to the surface and the temporary construction elements may be installed on the sheet in accordance with the markings. The sheets may then be removed and the temporary construction elements may be uninstalled when the event is completed.

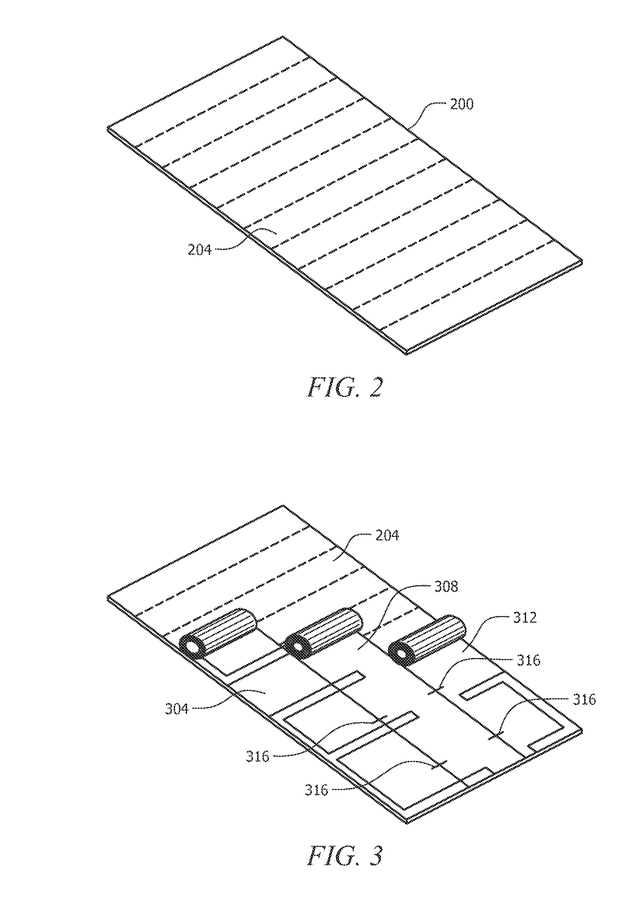

FIG. 2 illustrates a floor 200 on which a carpet 204 is laid. Booths and other construction elements may be installed on the carpet 204 for an event or may be installed directly on another surface, such as, for example, an uncovered floor. During installation of the booths and other construction elements, it may be desirable to protect the carpet 204 or other surface from damage.

FIG. 3 shows a full-scale architectural template comprising a plurality of sheets 304, 308 and 312 being laid on the carpet 204. The sheets 304, 308, and 312 are rolled out and laid on the carpet 204 side by side. A first sheet 304 may align with an edge of the carpet 204 and subsequent sheets 208 and 312 may be aligned to the first sheet 304. Adjacent sheets 304, 308 and/or 312 may overlap by a few inches. The sheets 304, 308 and 312 are then aligned with one or more points on the carpet 204 and with identifiers 316. When the sheets 304, 308 and 312 are properly aligned, they are attached or secured to the surface, for example, the carpet 204, and/or adjacent sheets 304, 308 or 312.

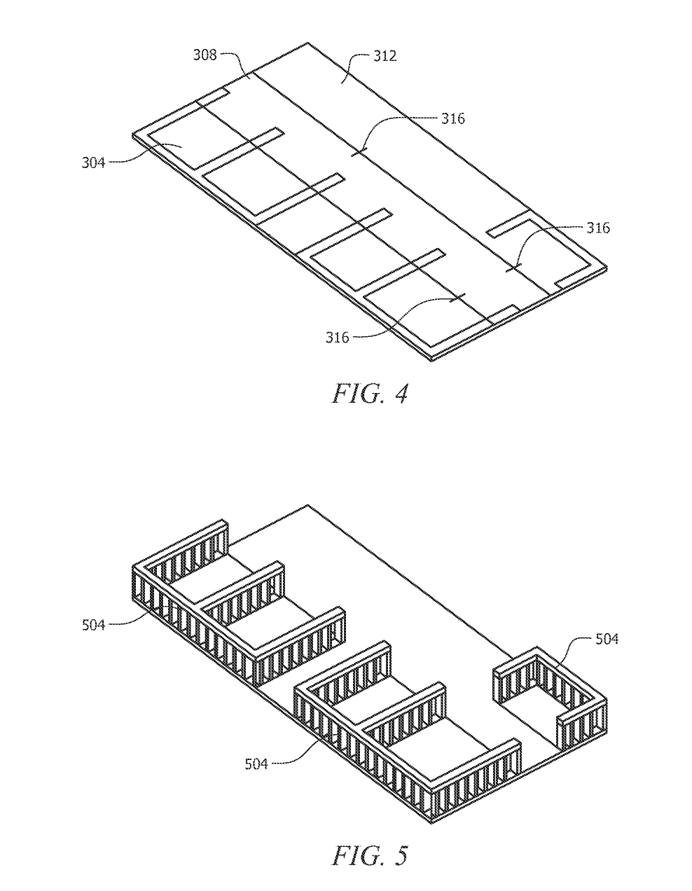

FIG. 4 shows the sheets 304, 308 and 312 being completely installed on the carpet 204. As shown in FIG. 4, the sheets 304, 308, and 312 display lines and other markings indicating the position of the booths and other temporary construction elements.

FIG. 5 shows booths 504 being installed directly on the sheets 304, 308, and 312. The markings displayed on the sheets 304, 308, and 312 are used as guides during installation. When the sheets 304, 308, and 312 are no longer needed after the construction elements have been installed, the sheets 304, 308, and 312 may be removed and discarded. The sheets 304, 308, and 312 may be cut out using a sharp blade or any other suitable tool and/or may be pulled out from under the temporary construction elements.

The foregoing description of illustrated embodiments, including what is described in the Abstract, is not intended to be exhaustive or to limit the claims to the precise forms disclosed herein. While specific embodiments and examples are described herein for illustrative purposes only, various equivalent modifications are possible within the spirit and scope of the present disclosure, as those skilled in the relevant art will recognize and appreciate. As indicated, these modifications may be made to the present disclosure in light of the foregoing description of illustrated embodiments and are to be included within the spirit and scope of the present disclosure.

Thus, while particular embodiments have been described herein, a latitude of modification, various changes and substitutions are intended in the foregoing disclosures, and it will be appreciated that in some instances some features of embodiments will be employed without a corresponding use of other features without departing from the scope and spirit of this disclosure. Therefore, many modifications may be made to adapt a particular situation or material to the essential scope and spirit of the present disclosure. It is intended that the disclosure not be limited to the particular terms used in the following claims and/or to the particular embodiment disclosed as the best mode contemplated, but that the claims will include any and all embodiments and equivalents falling within the scope of the appended claims. Thus, the scope of the invention(s) is to be determined solely by the appended claims.

What is claimed is:

1. A method of installing temporary construction elements for an event, the method comprising the steps of:
placing a sheet on a surface, the sheet comprising a portion of a full-scale architectural template having markings indicating the position of temporary construction elements;
removably attaching the sheet to the surface;
then installing the temporary construction elements on the sheet in accordance with the markings; and
then uninstalling the temporary construction elements.

2. The method according to claim 1, further comprising removing the sheet from the surface.

3. The method according to claim 1, further comprising aligning the sheet with an adjacent sheet by aligning alignment arrows of the sheet with alignment arrows on the adjacent sheet.

4. The method according to claim 1, wherein placing the sheet on the surface comprises placing a second sheet adjacent to the sheet so that a portion of the second sheet overlaps the sheet.

5. The method according to claim 1, wherein the sheet includes an advertisement printed on the sheet.

6. A method of installing temporary construction elements for an event, the method comprising the steps of:
placing a sheet on a surface, the sheet including a portion of an architectural template including markings indicating the position of temporary construction elements;
removably securing the sheets to the surface;
then installing the temporary construction elements on the sheet in accordance with the markings; and
then removing the sheet from the surface.

7. The method according to claim 6, wherein removing the sheet from the surface comprises pulling the sheet out from under the temporary construction elements.

8. The method according to claim 6, further comprising uninstalling the temporary construction elements.

9. The method according to claim 6, wherein placing the sheets on the floor comprises securing the sheet to an adjacent sheet so that a portion of the sheet overlaps the adjacent sheet.

10. The method of claim 6, wherein the sheets comprise grid lines as a background to aid in aligning the sheets.

11. The method of claim 6, wherein the temporary construction elements comprise at least one of portable furniture, a booth, a showcase, a temporary wall, a door and a cabinet.

12. A full-scale architectural template for installing temporary construction elements for an event comprising one or more sheets, each sheet being a portion of the full-scale architectural template, the sheets having markings indicating the position of the temporary construction elements for the event, wherein the temporary construction elements include at least one of portable furniture, a booth, a showcase, a temporary wall, a door and a cabinet.

13. The template according to claim 12, wherein the sheets are made of one or more of a vinyl material, a fabric and a plastic material.

14. The template according to claim 12, wherein the sheets are up to about 8 mm thick.

15. The template according to claim 12, wherein the sheets include a vinyl face and a woven nylon backing.

16. The template according to claim 12, wherein the sheets are made of a PVC coated woven nylon.

17. The template according to claim 12, wherein the sheets include a woven material.

18. The template according to claim 12, wherein the sheets include a non-woven material.

19. The template according to claim 12, wherein the sheets are made of a high density polyethylene.
